(19) United States
(12) Patent Application Publication
(10) Pub. No.: US 2010/0185974 A1
(43) Pub. Date: Jul. 22, 2010

(54) METHOD OF PRESENTING A SCHEDULE OF EVENTS

(75) Inventor: Deepak Pai, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/667,062

(22) PCT Filed: Jun. 27, 2008
(86) PCT No.: PCT/IB08/52592

§ 371 Date: Dec. 29, 2009

(30) Foreign Application Priority Data
Jul. 2, 2007 (EP) 07111502.6

(51) Int. Cl. G06F 3/048

(52) U.S. Cl. 715/781

(57) ABSTRACT

A method of presenting a schedule of events on a screen, includes obtaining data representative of events and associated time intervals of availability to a receiver (1,2) of signals corresponding to the events. Events having a time interval of availability within a time range are identified. Fields are displayed within a screen area such that at least one dimension of the screen area indicates a time frame, and a respective field (24-32) is associated with each event having a time interval of availability within the time frame and is caused to occupy a section of the screen area commensurate with the time interval's position within the time frame. The time frames duration is calculated on the basis of a shortest duration of a time interval of availability of any of the identified events.

### FIELD OF THE INVENTION

The invention relates to a method of presenting a schedule of events on a screen, including

obtaining data representative of events and associated time intervals of availability to a receiver of signals corresponding to the events;

identifying events having a time interval of availability within a time range; and

causing fields to be displayed within a screen area such that

at least one dimension of the screen area indicates a time frame, and

a respective field is associated with each event having a time interval of availability within the time frame

and is caused to occupy a section of the screen area commensurate with the time interval's position within the time frame.

The invention also relates to a system for controlling the display of a schedule of events, including:

an interface for obtaining data representative of events and associated time intervals of availability to a receiver of signals corresponding to the events;

a device for processing the data to identify events having a time interval of availability within a time range; and

an interface for providing image data to a display device, wherein the system is configured to provide image data causing the display device to display fields within a screen area such that

at least one dimension of the screen area indicates a time frame, and

a respective field is associated with each event having a time interval of availability within the time frame and is caused to occupy a section of the screen area commensurate with the time interval's position within the time frame.

The invention also relates to a receiver for receiving signals representative of events, including:

an interface for obtaining data representative of the events and time intervals of availability of signals corresponding to the events; and

a display device.

The invention also relates to a computer programme.

### BACKGROUND OF THE INVENTION

US 2006/0023116 discloses a programme-display control apparatus and a programme-display control method, which are used for displaying a table of television-broadcast programmes and/or a table of web programmes. A flowchart representing the operations carried out by the unit begins with a step to determine a maximum display line count L representing the maximum number of display lines in the one-hour frame being processed. Then, at a next step, a programme count N representing the number of programmes included in the time frame is found from received EPG (Electronic Programme Guide) information. Subsequently, the value of N is compared with the value of L to determine whether the value of N is smaller than or equal to the value of L. If the value of N is greater than the value of L, information on the programmes cannot be displayed for all the programmes. In such a case, the flow of the control goes on to a step at which programme-display concealment marks are displayed at pre-determined locations. In collaboration with control means, a time-frame enlargement display processor modifies display areas of programmes in accordance with an enlargement or enlargement cancellation command given by the user. When commands to enlarge a specified time frame are received, the specified time frame is enlarged to occupy the next time frame, step-by-step for each of the commands.

A problem of the known method and system is that it results in more commands from a user as a result of a manner of display that does not provide a very intuitive user interface. If there are few events in a time slot, then the user will have to provide more navigation commands to cycle through successive time slots than is necessary. If there are more events than can be displayed, additional user commands for enlarging time slots will have to be processed as the user attempts to uncover the information hinted at by the concealment marks.

### SUMMARY OF THE INVENTION

It is an object of the invention to provide a method, system, receiver and computer programme of the types mentioned in the opening paragraphs that provide a user-friendly display of information relating to scheduled events in an efficient manner.

This object is achieved by the method according to the invention by calculating the time frame's duration on the basis of a shortest duration of a time interval of availability of any of the identified events.

Because the time frame's duration is calculated in dependence on at least one variable, it is varied according to the time intervals associated with events. Variation in accordance with the shortest duration of a time interval of availability of any of the identified events means that, given that a respective field is associated with each event having a time interval of availability within the time frame and is caused to occupy a section of the screen area commensurate with the time interval's position within the time frame, it is assured that at least the smallest field will be sufficiently large to display a required amount of information. A certain minimum of information can be displayed with respect to each event in the face of varying frequencies of transitions between events. From the duration of the shortest event and the available extent of screen area for displaying fields, the time frame follows. The method avoids having to compress the fields into small sections of the screen area where there are many events with short associated time intervals of availability, such that any information conveyed by the fields becomes illegible. The method can be implemented automatically, by being dependent on data available to any system for controlling the display of the schedule of events that has an interface for receiving the data representative of events and associated time intervals of availability, so that repeated processing of user commands to alter the display of the fields is not required.

In an embodiment, the time frame's duration is calculated on the basis of

the at least one dimension of an available screen area and

a pre-determined size of a section of the screen area that a field associated with the event having the time interval of availability of shortest duration is to be caused to occupy.

Thus, it is ensured that a minimum of display area is available for each event available completely within the time frame indicated by the relevant dimension(s) of the screen area. Because each field is caused to occupy a section commensurate with the associated time interval's occupancy of the time frame, the events with larger time intervals of availability within the time frame will be associated with even larger fields.

In an embodiment, the screen area is partitioned along a dimension other than the dimension(s) indicating the time frame, and fields associated with time intervals of availability within the time frame are caused to occupy sections of the screen area additionally commensurate with categories indicated for the associated events.

An effect is that a relatively accessible and informative display is provided, wherein each event's information can still be displayed adequately with a minimum of user interaction. Categories may correspond to channels of transmission of signals corresponding to the events.

An embodiment of the method includes, for an event having a fraction of its time interval of availability within the time frame,

calculating at least one dimension of a section of the screen area along the dimension(s) indicating the time frame commensurate with the fraction's occupancy of the time frame, and

causing a field associated with the event to be displayed only if the calculated dimensions(s) exceed(s) a pre-determined value.

Thus, information relating to events lying predominantly outside the time frame is not displayed. An effect is that complicated iterative procedures to ensure that the time frame also allows for sufficient information to be displayed on events only partially within the time frame are avoided. The time frame can also be larger than would be the case if it were to be adjusted to give also the events with fractions of time intervals within the time frame sufficient space.

An embodiment of the method includes setting a starting point of the time frame to precede a starting point of the time range.

It is thus possible to display more information on events with time intervals of availability only partially overlapping the time frame without the need to re-size the time frame. It need merely be shifted.

An embodiment of the method includes

setting a starting time of the time frame such that any events having a fraction of a time interval of availability within the time frame at its start have a fraction within the time frame of longer duration than the shortest duration of a time interval of availability of any of the identified events.

Thus, the need to display information on events with small fractions of time intervals of availability within the time frame is avoided. Each event has sufficient overlap with the time frame. In particular, if the starting time of the time frame corresponds substantially with a current point in time, the schedule of events can automatically be sufficiently informative with regard to events currently available.

An embodiment of the method includes, if a starting point of the time frame precedes a certain point in time, displaying only fields associated with time intervals of availability ending after the certain point in time.

Thus, if a very short event just preceding the time range is contained within the time frame, the time frame need not be re-sized. In particular, if the certain point in time corresponds substantially to a current point in time as indicated by a clock, it is avoided that the time-frame's duration is re-calculated in order to display sufficient information on an event that is already no longer available.

According to another aspect, the system according to the invention includes a data processing device configured to calculate the time frame's duration on the basis of a shortest duration of a time interval of availability of any of the identified events.

The system is arranged to cause a sufficiently large field to be displayed for each event in the schedule without a great deal of involvement of any persons looking at the schedule of events.

An embodiment of the system is configured to execute a method according to the invention.

According to another aspect, the receiver according to the invention comprises a system according to the invention.

According to another aspect of the invention, there is provided a computer programme including a set of instructions which, when incorporated in a machine-readable medium, are capable of causing a system having information processing capabilities to perform a method according to the invention.

### BRIEF DESCRIPTION OF THE DRAWINGS

The invention will now be explained in further detail with reference to the accompanying drawings, in which:

FIG. 1 is a block diagram of a broadcast receiver;

FIG. 2 is a first screen view, resulting from the use of an electronic programme guide of a first type;

FIG. 3 is a second screen view, resulting from the use of an electronic programme guide of a second type;

FIG. 4 is a hypothetical screen view;

FIG. 5 is a third screen view, resulting from the use of an electronic programme guide of a similar type to the second type; and

FIG. 6 is a flow chart illustrating a method for adjusting the time frame represented in the grid shown in FIG. 5.

### DETAILED DESCRIPTION OF THE EMBODIMENTS

The present description will set out an example of a method of displaying an

Electronic Programme Guide (EPG), based on data representative of events encoded in a digital television signal. However, the same principles of the method can be applied to other types of events to which signals scheduled for transmission to receivers correspond. Examples include analogue television broadcasts, radio broadcasts, web-casts, and combinations thereof. The methods are not limited to use in conjunction with a single source of EPG data and/or signals corresponding to events.

The digital television signal is, for example, in the form of a plurality of multiplexed MPEG-2 Transport Streams, as known, for instance, from international standard ISO/IEC 13818-1. Each of the transport streams represents a component of a multiplexed set of streams defining a programme stream. As an example, there may be transport streams carrying one of a plurality of audio components, a transport stream carrying a video component, one or more transport streams carrying a data component, etc.

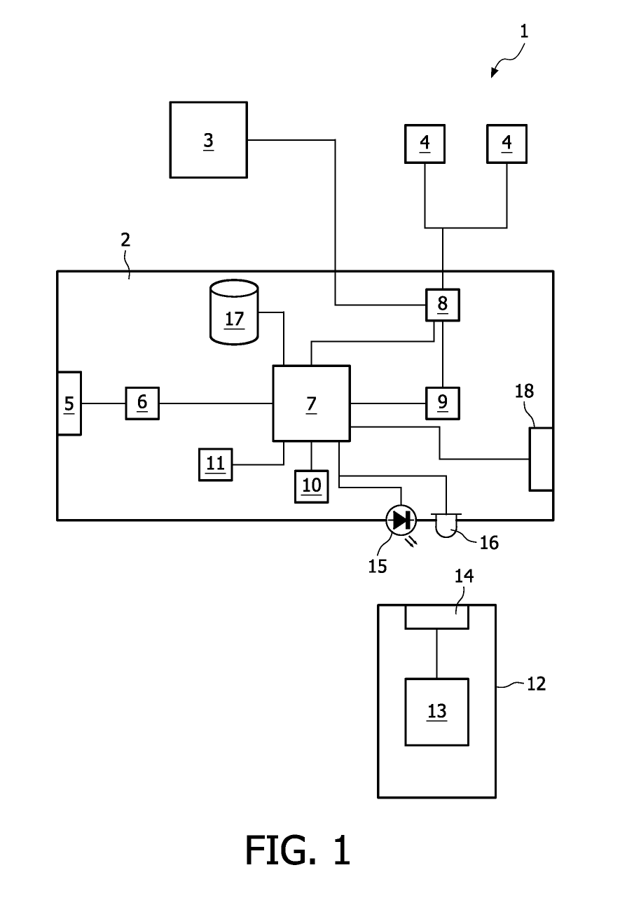

At least one of the components of the programme stream is sent separately to a system (not shown) for generating an electronic programme guide (EPG). The system provides a stream of data for generating an EPG on consumer premises equipment 1 (FIG. 1). The EPG enables selection of programmes that correspond to respective sections of a sequence of sections of a programme stream.

The EPG data stream is added to the programme streams by the broadcaster. The resulting digital television stream is coded by a coding system, in accordance with a particular transmission mode. The coded signal is then provided to a modulation and transmission system for dissemination. In yet other embodiments, the digital television signal stream is transmitted in data packets, for example Internet Protocol packets, over a communication network. In another embodiment, the programme stream is transmitted over a data communication network in response to a request from a receiver. The programme stream may also be transmitted by recording on a physical data carrier and distribution of this data carrier. In such an embodiment, signals corresponding to events can also be scheduled for availability in the sense that access to them may be restricted to certain time intervals using, for example a Digital Rights Management system. In any of these embodiments, the EPG data stream can be transmitted separately, using a different medium if required.

In one example, the EPG is in the form of tables, for example one table for each programme. Each table constitutes a data set associated with one of a sequence of programmes. A table associated with a programme may be linked to, or contain within it, tables associated with programme parts.

FIG. 1 illustrates an example of consumer premises equipment 1 for providing an Electronic Programme Guide (EPG). It comprises a set-top box 2, a Visual Display Unit (VDU) 3 and a sound system 4. The VDU 3 may be an analogue television set of a known type. The set-top box 2 comprises a tuner module 5 for receiving a terrestrial, satellite or cable broadcast signal, a channel decoder 6 for obtaining an MPEG-2 transport stream comprising programme streams, and a source decoder 7.

The source decoder 7 includes a central processing unit core, a demultiplexer engine and, optionally a descrambler. It further includes an audio digital signal processor, as well as an encoder for providing a video signal to the VDU 3 via an audio/video switch 8. An audio signal is provided to the sound system 4 via a digital-to-analogue converter (DAC) 9 and the audio/video switch 8. An EEPROM memory module 10 contains a compressed computer program code for execution by the CPU core of the source decoder 7. The decompressed code is loaded into RAM memory module 11 when the set-top box 2 is started up. Amongst others, the code implements a graphics engine capable of generating an electronic programme guide (EPG) on the consumer premises equipment 1.

The consumer premises equipment provides the EPG through an interactive graphical user interface. The source decoder 7 parses the EPG data to generate a menu for display on the VDU 3. Selection commands and other user input are provided by a remote control unit 12, including a keypad 13 and infrared transceiver 14. The set-top box 2 includes a corresponding infra-red transmitter 15 and receiver 16. By means of the selection commands, a user can select a scheduled programme or at least a component of a programme part for reproduction on the VDU 3 and sound system 4. He can also select the same for recording, to which end the set-top box 2 comprises a storage device 17. The storage device 17 may be arranged to record the programme on a portable recordable medium, such as an optical disk. In the illustrated embodiment the storage device 17 comprises a hard disk unit.

The illustrated set-top box 2 includes an (optional) network interface 18, for receiving a data stream from a network server (not shown). Part or all of the EPG data may be received through the network interface 18 instead of with the digital television signal.

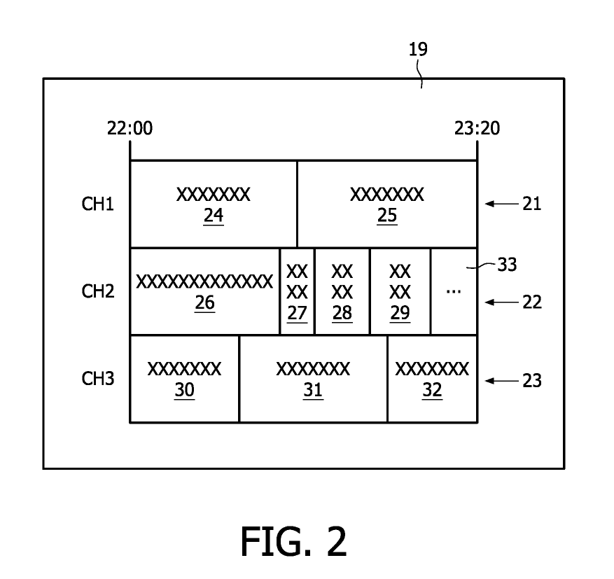

A simplified first screen view 19 (FIG. 2) illustrates the basic layout of a first variant of an EPG interface as displayed on the VDU 3. The first screen view 19 is generated by the graphics engine implemented in the source decoder 7. Selections can be made by controlling a cursor (not shown), using the keypad 13 on the remote control unit 12.

The first screen view 19 includes a grid 20. The grid 20 occupies a pre-determined area of the screen, which may be variable in dependence on parameters set by the user or determined by the menu structure of the EPG. The horizontal dimension of the area in which the grid 20 is displayed indicates a time frame. Start and end times of the time frame are indicated next to the grid 20. It is observed: that alternative forms of grid are possible. For example, the vertical dimension may indicate the time frame. In another embodiment, a grid formed of concentric circle segments is used, and the radial dimension indicates the time frame. Thus, the area occupied by the grid 20 need not be rectangular in shape.

The grid 20 is a multi-dimensional grid, partitioned into rows 21,22,23 in the vertical direction. Each row 21,22,23 corresponds to a programme stream, i.e. a channel through which signals corresponding to consecutive events are transmitted. The EPG may provide for an alternative to the first screen view 19 in which the rows 21,22,23 correspond to different categories of events according to categorisation data included in the EPG data and referring to their content. For example, there may be a row for movies, a row for current affairs programmes and a row for drama.

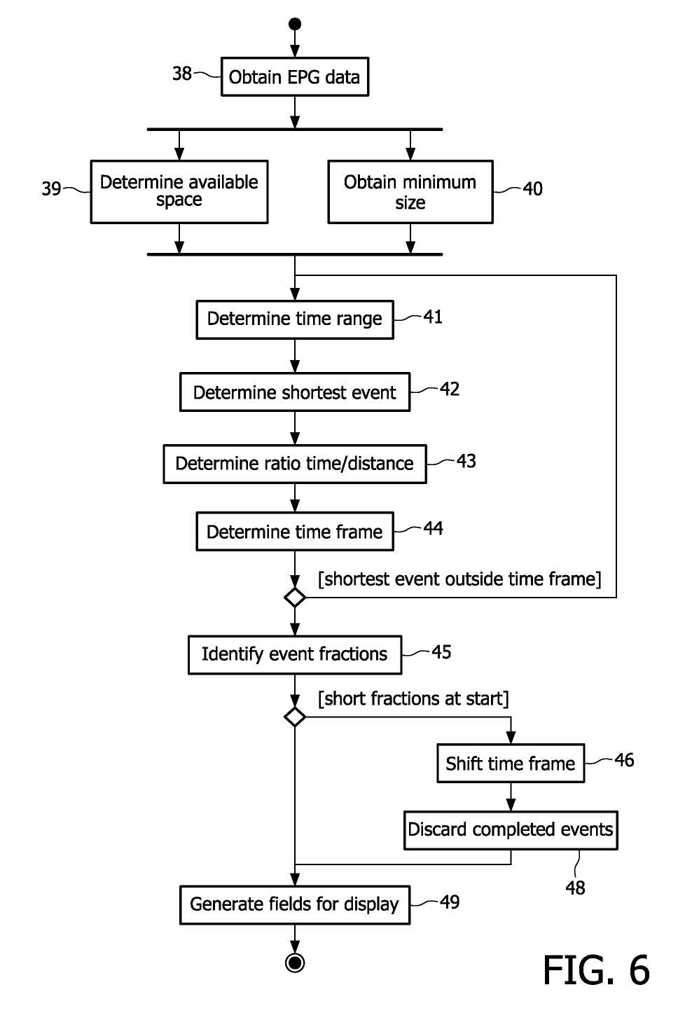

The grid 20 is partitioned, within each row 21,22,23, into fields 24-32. Each field 24-32 contains a display of information relating to a respective associated event that is available within the indicated time frame on one of the channels. Boundaries of the fields 24-32 in the direction parallel to the dimension of the grid 20 that indicates the time frame of display are positioned to reflect the start and end times of the event relative to the time frame. However, each field 24-32 is sufficiently large that a minimum of information can be displayed. This is achieved by adjusting the duration of the time frame represented by the grid 20 in a manner illustrated in FIG. 6, and to be explained in more detail below.

In general, the time frame's duration is set in dependence on the available horizontal screen space, the duration of the shortest event within a time range starting at a current point in time and extending to a default value, and the minimum horizontal screen space for any field. The duration of the shortest event and the minimum horizontal screen space determine the horizontal screen space per unit time. The horizontal screen space per unit time and the available horizontal screen space for the grid 20 determine the duration of the time frame.

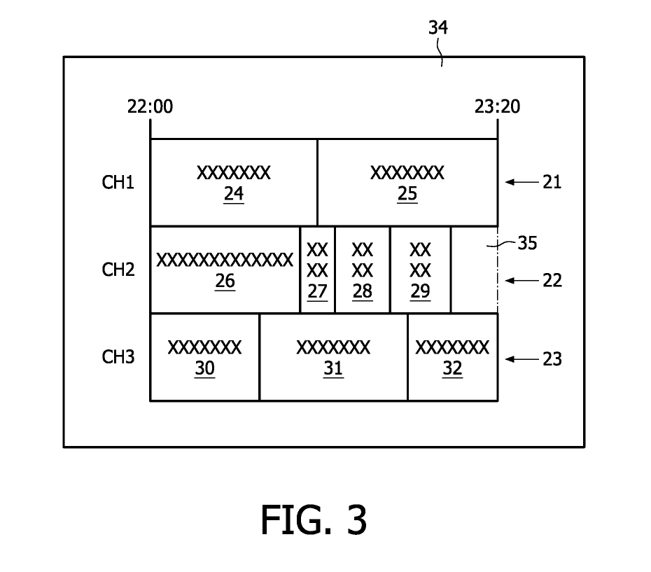

FIGS. 2 and 3 depict a situation in which an event with an associated time interval of availability overlapping the end point of the time frame has only a fraction of its time interval of availability within the time frame. In the embodiment of FIG. 2, the set-top box 2 has calculated the horizontal dimension of a section of the screen area reserved for the grid 20 commensurate with the fraction's occupancy of the time frame and determined that it is smaller than a pre-determined minimum value. For those events for which it is determined that this is the case, a field 33 of default appearance is displayed, indicating that the associated event has a time interval of availability extending beyond the duration of the time frame. This field 33 has an appearance determined by default settings independent of any information associated with the event. If a user gives a command to shift the time frame, then the field 33 will morph into one displaying information on the associated event.

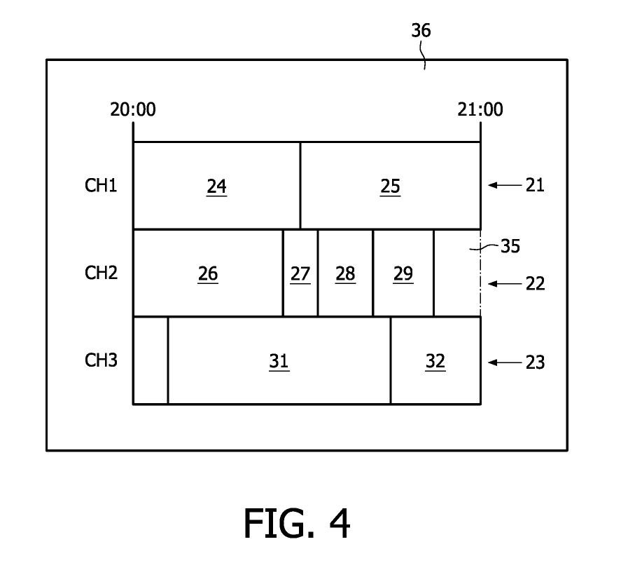

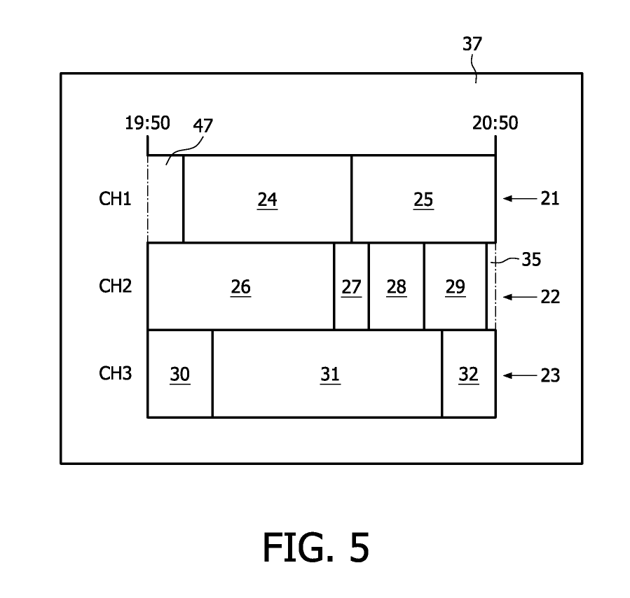

In an alternative embodiment, as depicted in FIG. 3 and also in FIGS. 4 and 5, the horizontal dimension of a section of the screen area reserved for the grid 20 commensurate with the fraction's occupancy of the time frame is also calculated. For those events for which it is determined that the size of the section is smaller than a pre-determined minimum value, no field is displayed. Thus, a second screen view 34 contains a screen area corresponding to the grid 20, but with a vacant section 35 left unoccupied by the grid 20.

FIGS. 4 and 5 illustrate a hypothetical screen view 36 and an actual third screen view 37 to explain the method depicted in FIG. 6.

In a first step 38, the set-top box 2 acquires data representative of broadcast events and associated time intervals of broadcast. The data may further include data classifying events into one or more categories. In the illustrated embodiment, the screen area available for the grid 20 is variable. For this reason, the value of the horizontal dimension of the screen area available for the grid 20 is read (step 39). The value of the minimum horizontal field size is also read (step 40).

The set-top box 2 is arranged to examine the data representative of events with associated time intervals of availability within a certain time range. This time range is determined (step 41) next. The time range will generally commence at the current point in time as determined by a clock (not shown) and extend over a certain period of time. The period may be equal to a default value, for instance, serving as a first estimate of the time frame.

The shortest duration of any event across all categories or channels to be displayed in the grid 20 is determined (step 42). Generally, this is the duration of the shortest event completely contained within the time range. The conversion factor between time and horizontal distance on the screen is determined (step 43). This is done by dividing the minimum horizontal field size by the duration of the shortest time interval determined in the previous step 42. The horizontal extent of the screen area reserved for the grid 20 and the conversion factor determine the duration of the time frame.

It can happen that the shortest event within the time range does not fall within the time frame, because the latter does not extend as far into the future as the time range. In that case, the steps 41-44 just described are repeated using a smaller time range as an initial guess for the time frame.

Events with time intervals of availability of which only a fraction is contained within the time frame are subsequently determined (step 45). If there are fractions at the start of the time frame having a shorter duration than the duration of the shortest event as determined in the preceding step 42, then the time frame is shifted 46 to set the starting time of the resultant time frame at such a point in time that any events having a fraction of a time interval of availability within the time frame at its start have a fraction within the time frame of longer duration than the shortest duration of a time interval of availability of any of the events in the time range on which the time frame's duration was based. This is depicted in FIGS. 4 and 5. FIG. 4 shows a situation in which a potentially visible part of a field 30 associated with an event with a fraction of a time interval within the time frame is too small to display sufficient information about this event. FIG. 5 shows the grid 20 after the time frame has been shifted, so that the starting point of the time frame precedes the current point in time. In order to prevent there being insufficient space to display information on a very short event broadcast on a first channel and falling within the shifted time frame as a result of the shift, a region 47 is left vacant, so that only fields associated with time intervals of availability ending after the starting time of the original time frame (20:00) are displayed. Complete events or fractions of events ending before the current point in time are not displayed on the grid 20. Instead, information relating to such events is discarded (step 48).

Finally (step 49) fields are caused to be displayed within the screen area reserved for the grid 20. A respective field 24-32 is associated with each event having a time interval of availability within the (shifted) time frame and is caused to occupy a section of the screen area commensurate with the time interval's position within the time frame. By this is meant that the boundaries of such fields are placed along the horizontal dimension of the grid 20 at positions proportionate to the location within the time frame of the starting and end times of the associated events relative to the time frame. There is automatically sufficient space to display a certain minimum of information on the associated events in the fields 24-32.

It should be noted that the embodiments described above illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. ‘Computer program’ is to be understood to mean any software product stored on a computer-readable medium, such as an optical disk, downloadable via a network, such as the Internet, or marketable in any other manner.

In an alternative embodiment to those outlined above, a remote server carries out a method of presenting a schedule of events as detailed herein. The resulting fields associated with events are caused to be displayed within a screen area by sending graphical data for rendering one of the screen views 19,34,37 to the set-top box 2, e.g. through a network to which the network interface 18 provides access.

1. Method of presenting a schedule of events on a screen, including
obtaining data representative of events and associated time intervals of availability to a receiver (1,2) of signals corresponding to the events;
identifying events having a time interval of availability within a time range; and
causing fields (24-32) to be displayed within a screen area such that
at least one dimension of the screen area indicates a time frame, and
a respective field (24-32) is associated with each event having a time interval of availability within the time frame
and is caused to occupy a section of the screen area commensurate with the time interval's position within the time frame, wherein the method further includes
calculating the time frame's duration on the basis of a shortest duration of a time interval of availability of any of the identified events.

2. Method according to claim 1, wherein the time frame's duration is calculated on the basis of
the at least one dimension of an available screen area and
a pre-determined size of a section of the screen area that a field associated with the event having the time interval of availability of shortest duration is to occupy.

3. Method according to claim 1, wherein the screen area is partitioned along a dimension other than the dimension(s) indicating the time frame, and wherein fields associated with time intervals of availability within the time frame are caused to occupy sections of the screen area additionally commensurate with categories indicated for the associated events.

4. Method according to claim 1, including, for an event having a fraction of its time interval of availability within the time frame,
calculating at least one dimension of a section of the screen area along the dimension(s) indicating the time frame commensurate with the fraction's occupancy of the time frame, and
causing a field associated with the event to be displayed only if the calculated dimensions(s) exceed(s) a pre-determined value.

5. Method according to claim 1, including setting a starting point of the time frame to precede a starting point of the time range.

6. Method according to claim 1, including
setting a starting time of the time frame such that any events having a fraction of a time interval of availability within the time frame at its start have a fraction within the time frame of longer duration than the shortest duration of a time interval of availability of any of the identified events.

7. Method according to claim 5, including, if a starting point of the time frame precedes a certain point in time, displaying only fields associated with time intervals of availability ending after the certain point in time.

8. System for controlling the display of a schedule of events, including:
an interface (5,6,7,18) for obtaining data representative of events and associated time intervals of availability to a receiver of signals corresponding to the events;
a device (7,11) for processing the data to identify events having a time interval of availability within a time range; and
an interface (8) for providing image data to a display device (3), wherein the system is configured to provide image data causing the display device (3) to display fields (24-32) within a screen area such that
at least one dimension of the screen area indicates a time frame, and
a respective field (24-32) is associated with each event having a time interval of availability within the time frame and caused to occupy a section of the screen area commensurate with the time interval's position within the time frame,
wherein the data processing device (7,11) is configured to calculate the time frame's duration on the basis of a shortest duration of a time interval of availability of any of the identified events.

9. System according to claim 8, configured to execute a method of presenting a schedule of events on a screen, including
obtaining data representative of events and associated time intervals of availability to a receiver (1,2) of signals corresponding to the events;
identify events having a time interval of availability within a time range; and
causing fields (24-32) to be displayed within a screen area such that
at least one dimension of the screen area indicates a time frame, and
a respective field (24-32) is associated with each event having a time interval of availability within the time frame
and is caused to occupy a section of the screen area commensurate with the time interval's position within the time frame, wherein the method further includes
calculating the time frame's duration on the basis of a shortest duration of a time interval of availability of any of the identified events.

10. Receiver for receiving signals representative of events, including:
an interface (5,6,7,18) for obtaining data representative of the events and time intervals of availability of signals corresponding to the events; and
a display device (3),
wherein the receiver comprises a system according to claim 8.

11. Computer programme including a set of instructions capable, when incorporated in a machine-readable medium, of causing a system having information processing capabilities to perform a method according to claim 1.
